(19) United States
(12) Patent Application Publication
(10) Pub. No.: US 2011/0229775 A1
(43) Pub. Date: Sep. 22, 2011

(54) Device for Efficient, Cost-Effective Conversion of Aquatic Biomass to Fuels and Electricity

(75) Inventors: Anthony F. Michaels, Palos Verdes Estates, CA (US); David A. Caron, Palos Verdes Estates, CA (US); Kenneth H. Nealson, Los Angeles, CA (US)

(73) Assignee: PHYCOSYSTEMS, INC., El Segundo, CA (US)

(21) Appl. No.: 13/120,418

(22) PCT Filed: Sep. 22, 2009
(86) PCT No.: PCT/US2009/057920

§ 371 Date: Jun. 8, 2011

Related U.S. Application Data
(60) Provisional application No. 61/099,177, filed on Sep. 22, 2008.

(51) Int. Cl. H01M 8/16

(52) U.S. Cl. 429/401

(57) ABSTRACT

A continuous system for growing algae, processing it and converting it into electricity, fuel and animal feed. The system utilizes an algae bioreactor which feeds harvested algae to a biomass extraction system which in turn directs a portion of the harvested algae to a microbial generator. The microbial generator converts the algae into electricity, water and nutrients. The biomass extraction system includes a dewatering device and a biomass dryer. The microbial generator in a preferred embodiment is a microbial fuel cell. Dry algae product used for animal feed, fuel, and the like is obtained from the output of the biomass dryer.

### SUMMARY OF THE INVENTION

Algae are the fastest growing plants and effectively convert solar energy to chemical energy through photosynthesis. This chemical energy fuels food webs in nature and has been proposed as one of the most promising sources of renewable energy through the production of biofuels. The multi-component device described here efficiently and cost-effectively grows algae and algae-dominated artificial ecosystems and then converts the organic matter into electricity and biomass that can be used for renewable fuels and food.

### BRIEF DESCRIPTION OF THE DRAWINGS

FIG. 1 is a block diagram illustrating the interconnection of a photo bioreactor, a biomass extraction system and a microbial generator.

FIG. 2 is a schematic diagram of an algae bioreactor utilizing a tiered raceway connected to pumps, a microbial generator, a de-watering system and a de-gassing system.

FIG. 3 is a schematic illustration of a first embodiment of a microbial generator.

FIG. 4 is a schematic diagram of a second embodiment of a microbial generator

### DETAILED DESCRIPTION OF THE INVENTION

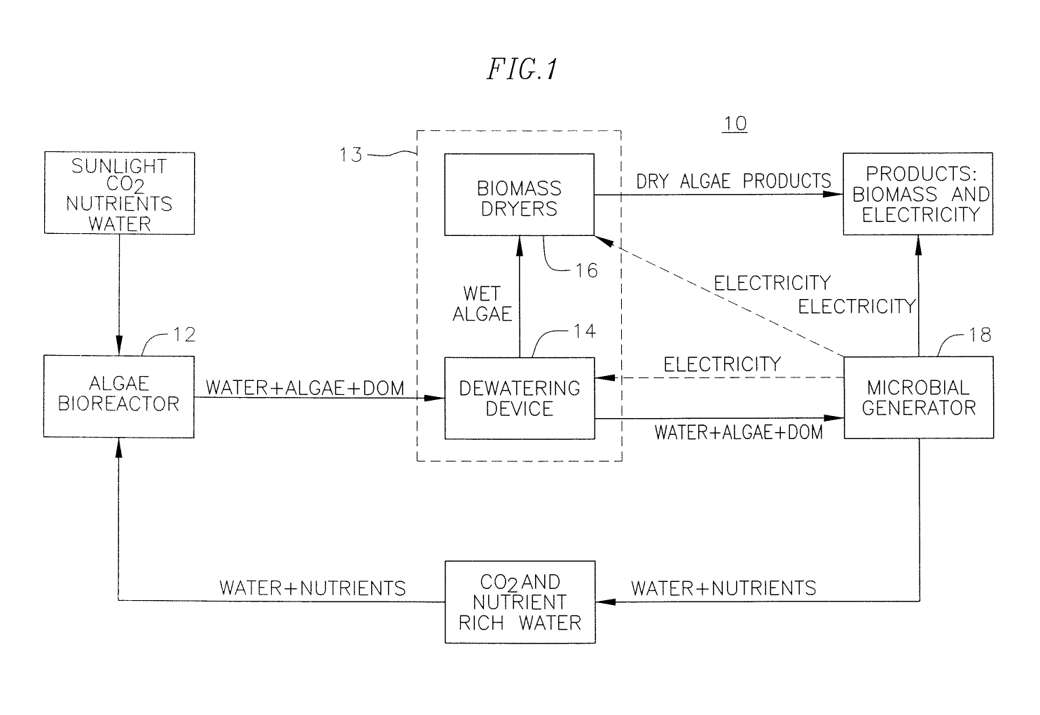

The apparatus 10 consists of three inter-connected systems, a photo-bioreactor 12, a biomass extraction system 13 (dewatering device 14 system and biomass dryer 16) and a microbial generator 18 as shown in FIG. 1.

The bioreactor 12 holds water and algae in an internal environment that enhances the growth rates of the algae. The bioreactor must also be supplied with replacement carbon dioxide, major nutrients, trace metals and required organics that are used by the algae for their growth. In an ideal installation, the carbon dioxide and nutrients come from an industrial or municipal waste application (e.g. power-plant exhaust, animal farm, fish farm, city waste treatment facility). The key objective is to produce as much organic biomass as possible at the most reasonable price. Thus, waste nutrient sources are preferred. However, in practice, any regular source of nutrients that replaces those that are used as fast as they become scarce (rate limiting) will be optimal.

### Photo-Bioreactors

The algae bioreactor 12 is a device that allows algae or algae-dominated, multi-species ecosystems to grow at a fast rate compared to nature and under conditions that are proscribed by the user according to their needs and the requirements of the product. These can range from simple ponds to highly complex, three-dimensional devices. Simple ponds and raceways are inexpensive, but tend to have slower growth rates and, unless they use special biological systems, more frequently have biological invasions and disease losses. Complex, closed bioreactors are much more expensive, but they maximize the growth-rates of the algae and minimize the impacts of other organisms by more easily maintaining a uni-algal culture. In its most common form, the device is a “raceway”, a set of long channels connected to each other in a continuous, recirculating track. These raceways have one or more devices for keeping the water flowing, in the same direction, such as a paddlewheels system, a pumping system or a directional aeration system. Raceways can also be constructed on a slope to take advantage of gravity to maintain flow with a pumping system at the base to return the water and algae to the top of the raceway.

Gas exchange can be enhanced by the creation of ripples and breaking waves on the surface of an open bioreactor or raceway and by stirring of the waters to replace the surface layer with subsurface waters. Some of this can be accomplished with the motors, aerators, paddlewheels and pumps. In a long, sloped raceway that uses gravity to provide flow, small steps, waterfalls and other uneven elements of the raceway design can disturb the surface and enhance gas exchange.

Carbon dioxide represents a special case since it is present in the atmosphere at low concentrations. Aeration of the bioreactor with air can provide small amounts of CO2. Aeration with a high-carbon dioxide gas makes this more efficient. This can be provided from an industrial gas source or may be coupled to a power plant or other industrial exhaust system. As discussed below, the addition of CO2 by aeration can also be coupled to the degassing of oxygen prior to use in the microbial generator, thus adding CO2 and stripping oxygen in the same step. The CO2 will generally stay in solution long enough that the enhanced CO2 from aeration and from the respiration in the microbial generator will both be available for photosynthesis when those waters are reintroduced to the bioreactor.

The preferred size of a bioreactor or bioreactor system for industrial production of biomass and electricity is 1-100 acres, but may other sizes are possible. These bioreactors will be arrayed in groups to get economies of scale as they feed the dewatering and electrical generation systems. It is anticipated that the appropriate scale for efficient operation in the present invention is likely to be about 1000-2000 acres, but much smaller and larger versions may also prove cost-effective as the components become available to operate at those scales. Larger operations are likely to be attained by co-locating replicate copies of the smaller units.

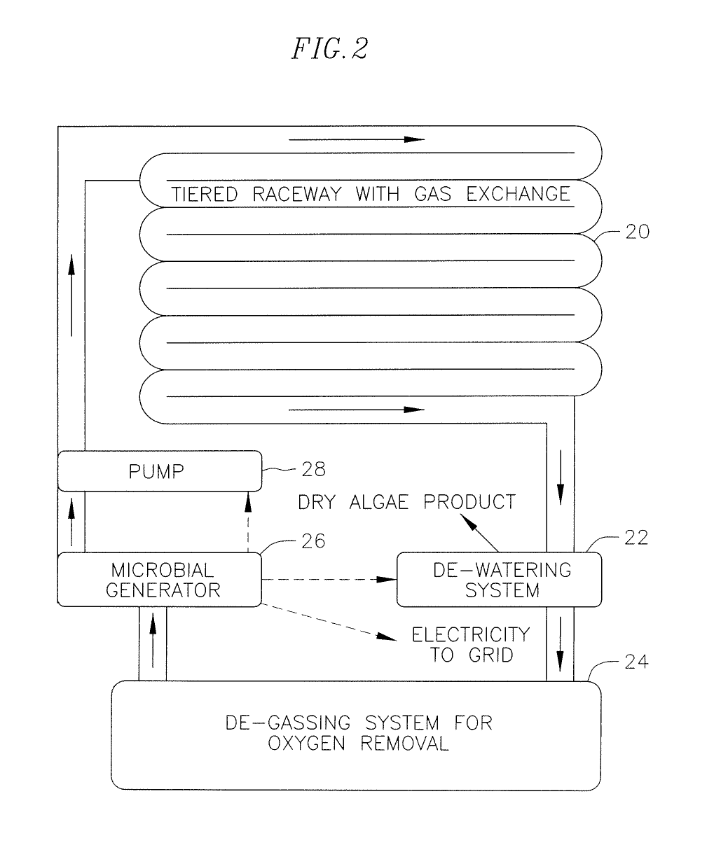

FIG. 2. One implementation of the complete system of the present invention is described in FIG. 2. The algae are grown in a bioreactor, one of many types of devices that provide the appropriate conditions to grow algae or algae-dominated aquatic ecosystems. These effectively take sunlight energy and inorganic nutrients and CO2 and store the sunlight energy as the chemical bonds in organic matter through photosynthesis. Some of this chemical energy is transferred to bacteria, protists and other organisms through food web dynamics and some is leaked into the water as dissolved organic material. In FIG. 2, a bioreactor is shown as a tiered raceway 20 (algae bioreactor) where the algae are pumped to the top of the raceway and kept in constant movement by gravity. Raceway 20 can also be replaced by any of a variety of other devices including ponds, oval raceways, recirculating raceways and fully enclosed bioreactors. The water is extracted from the raceway by a dewatering system 22. This device includes any of a variety of types of components that can effectively separate some or all of the algae from the water. These may include filters, screw presses, centrifuges, vacuum screens, flocculation and settling, dissolved air flocculation and many other devices. The separated algae are removed and processed into targeted energy or food products. The effluent from which the algae were removed is moved into a degassing system 24. This effluent contains any algae or other particles that were not removed and any dissolved materials that were also not removed or were added during dewatering. In some implementations of this system, the dewatering system 22 can be eliminated and the raceway bioreactor water can be transferred directly to the degassing system 24. The degassing system 14 removes excess oxygen and then provides for the biological removal of the rest of the oxygen through respiration. It can be as simple as a pipe with adequate residence time of the water to ensure that all oxygen is consumed by bacteria or something more complex that accomplishes the same function. The oxygen-free effluent then passes to a microbial generator 26. The microbial generators are any of a variety of devices that can produce electrical current using the principles of a microbial fuel cell. These devices effectively insert a wire in the electron transport system of biological respiration, usually be using bacteria that can use a wire as the terminal electron acceptor. In the process, the bacteria produce electricity from the dissolved and particulate organic matter in the effluent, converting the organic matter to carbon dioxide and inorganic nutrients. The inorganic nutrients are then passed back to the bioreactor to fuel the growth of new algae and biomass. In the example in FIG. 2, the transfer of the effluent from the microbial generator 26 to the raceway bioreactor 20 uses a pump 28 to provide the lift back to the top of the tiered raceway. In other implementations the pump 28 can transfer water up an elevation at any other part of the water cycle and use gravity or water pressure for the rest of the flows.

### Biomass Harvest and Dewatering

Once the biomass in the bioreactor has reached a certain level of production (a target production in grams per square meter per day or grams per liter), harvest can begin and will be a regular and ongoing activity but for system crashes or maintenance. The organisms in the bioreactor have a biological doubling rate, a parameter which is measured directly (and can change with seasons and circumstances). This determines the harvest rate. Continuous extraction makes the bioreactor behave like a chemostat—however, in this situation, the system must be optimized for both the harvest rate (percentage of water per hour) and the standing stock at that doubling rate. Alternately, the bioreactor can be harvested at discrete times (i.e. half of the system can be harvested once per day for a system that doubles every day).

For harvesting, algae-filled water is removed from the bioreactor by pumping or gravity flow. It will generally contain biomass at 0.01-2.0% suspended solids. Some versions of the device may allow a very large biomass to build up to the point where light limitation slows the net growth rates for new material. The high biomass will enhance the ease and cost-efficiency of harvest and dewatering. At high biomass, flocculation may also be easier to stimulate, thereby reducing dewatering costs at the expense of total production. Alternately, the bioreactor can be maintained at the highest possible rate of harvest, in this case a biomass level will be much lower and not light or nutrient limited. This will give higher total yield, but the costs of removal of the biomass at all size ranges will be higher. The invention described herein requires this flexibility in the choices of harvest as one of the key variables in choosing the balance between making electricity versus biomass.

In order to remove some of the particulate matter, some portion of the water from the bioreactor flows through a dewatering system. These systems are designed to remove some of the biomass and the choice of system and the level of effort within any system is part of the engineered or dynamic balance of this invention. At its simplest, the dewatering system will be a screen (for example a 100 micrometer screen) to remove relatively large algae. Large mesh sizes take less material (only the largest particles and aggregates) at lower costs in terms of electricity, pumping, residence time and damage to the material. Fine meshes take more material at higher costs and power. Flocculation and other pre-treatments can also aggregate the smaller cells into larger aggregates that can be retained on a large-mesh screen. Depending on the loading before it is cleaned, the screen will also aggregate finer algae with increased power requirements to force water through the loaded screen. In some versions, dewatering uses a more complex technology like a filter press, belt filter, screw press or industrial centrifuge. Each of these removes more and smaller particles from the water at a larger cost in energy and capital. As with the initial screening, the more that the extraction is pushed to remove finer and finer particles, the more power that will be consumed. Commercial devices like these are available from many manufacturers such as Siemens. The products of the dewatering are a slurry or cake of highly concentrated algae. These can be further dried and compressed for transport depending on the final product.

The biomass product of the present invention will be used for energy, agriculture, pharmaceuticals or food applications. Algae contain valuable oils that can be extracted and converted to fuel. Cake algae can be processed into fish food and animal food supplements. The biomass can be fed into industrial energy systems as a supplement to coal or even as a replacement. Algae can be gasified and turned into syngas which is then available for conversion to biodiesel, jet fuel and a variety of other liquid energy fuels through processes like Fischer-Tropsch synthesis. Many other uses are possible, depending on the algal source and the industrial intent.

The effluent from the dewatering system contains algae that are smaller than the dewatering system can process, bacteria, protists, particulate and dissolved organic matter. As algae grow and as some of them are eaten by heterotrophs in the bioreactor, they leak dissolved organic matter into the water. This material is of a very heterogeneous composition but will include things like sugars, lipids, proteins, complex carbohydrates, nucleic acids and many other compounds. All of these contain some of the solar energy that was originally created by the algae through photosynthesis. In a normal application, dissolved organic matter may include about a third of the chemical energy created by photosynthesis. This effluent is further processed in the microbial generator.

### Microbial Generator

The effluent from the dewatering is processed by a “microbial generator”. This device is an application of one of the variety of devices that are also described as microbial fuel cells. These devices are very versatile in the types of organic matter that they can process into electricity. They are also “self-healing” because the electricity production is conducted by a biological biofilm that regrows if it is disturbed or damaged.

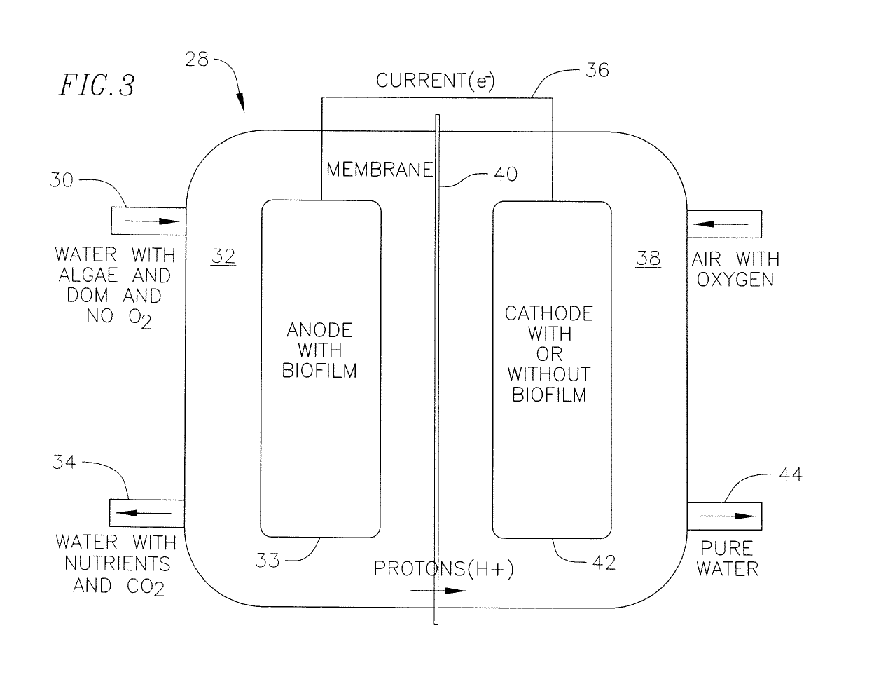

These devices have two chambers separated by a selectively permeable membrane that allows protons to pass. In the anode side of the chamber, anoxic fluids with organic matter are passed over an anode. An anode can be any of a variety of materials with large surface areas and of a material that can accept electrons from microbes, such as various metals, carbon or certain aerogel materials. Specially selected or modified bacteria grow as a biofilm enabled by the surface of the anode. The special bacteria use the anode as their terminal electron acceptor in respiration. They pass the electrons to the anode and the electrons pass through a wire to the cathode side of the generator. The cathode side of the fuel cell includes a terminal electron acceptor like oxygen. It uses the oxygen in the air to accept the electrons after they pass through a wire and these are combined with protons that flow through the membrane, thus producing water (see FIG. 3). Cathodes can be of special metals like platinum or they can be simple materials coated by special bacteria that receive the electrons from the cathode and live on the electron flow to the respiration of oxygen. Cathodes can also get their oxygen from the air or from the water. If they receive oxygen from water, this side of the microbial generator can also be used to help reduce the oxygen levels in the water before it goes into the anode. Thus, as they respire the organic matter in the effluent (both particulate and dissolved), the bacteria on the anode create a current to the cathode. Properly designed and with the correct microbial assemblage, microbial fuel cells have a high coulombic efficiency at a low voltage. This low voltage is later converted to the higher voltages used by electric motors and the electricity grid.

FIG. 3. The general principles of the microbial fuel cell are illustrated in FIG. 3. Water that includes algae, other particles and dissolved organic matter and that lacks oxygen enters the anode side 32 of the microbial generator 28 though the input port 30. In FIG. 2, this water comes from the degassing device 24. The water solution comes in contact with the anode 33 which is coated with microbes that can use the anode as their terminal electron acceptor. These microbes respire the organic matter and convert it to inorganic nutrients and CO2 which remain in the water and leave the anode side of the microbial generator 28 through the exit port 34. The microbes have passed their electrons to the anode 33 which are then able to flow through a wire 36. The other half of the chamber is the cathode side 38 which is separated from the anode side 32 by a proton permeable membrane 40. This membrane will let protons through but not water or any of the organic matter. On the cathode chamber 38, air or pure water enters through an input port 42. This air or water contains oxygen. On the cathode side of the chamber 38, is a cathode 42 that can either be coated with bacteria or includes an inorganic material or metal (like platinum) that facilitates the combination of the electrons from the wire 36 and the protons that passed through the membrane 40. Two electrons, two protons and one oxygen combine to make water which leaves through the exit port 44.

The water entering the anode of the microbial generator must have few electron acceptors like oxygen or sulfate. In freshwater, this is accomplished by removing the oxygen (there are few other natural electron acceptors in fresh water). In seawater versions of the device, special bacteria must be used to compensate for the presence of electron acceptors like sulfate or nitrate. These devices are particularly efficient in alkaline waters.

In most versions of this invention, the effluent from the dewatering device must first pass through a chamber where the natural biological activity of the bacteria, algae and heterotrophs consumes all of the available oxygen. This respiration is a loss of energy and should be minimized where possible as every bit of chemical energy consumed by respiration is energy that cannot be turned into electricity (within the bounds of the cost and effort optimization that is the benefit of this invention). As mentioned above, degassing of oxygen by aeration with air or low oxygen, high CO2 waters will facilitate this process as well as return carbon dioxide to the system. Some of the water can be passed through the cathode end of the microbial generator as a cost-effective method of removing oxygen without reducing the energy content of the suspended organic matter that will be processed in the anode chamber. In freshwater, with its general lack of alternative electron acceptors (like sulfate in salt water), the device may also include a digester that converts some of the complex organic matter to lactic acid and other labile organics. This also reduces oxygen and makes the microbial generator more efficient.

The effluent from the microbial generator will have large amounts of inorganic nutrients and carbon dioxide from the respiration within the microbial generator. This water is then passed back to the bioreactor to provide nutrients for the next round of biological growth.

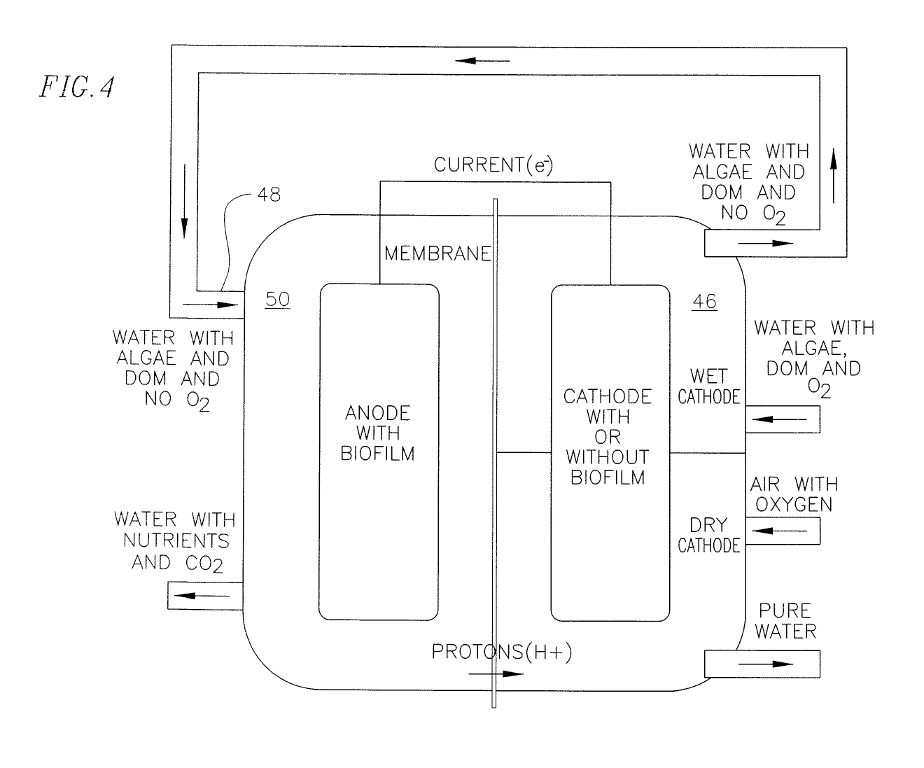

FIG. 4. Here is shown a modified version of the microbial fuel cell system as described in FIG. 3. This modification combines the degassing function (FIG. 2, device 24) with the microbial fuel cell components as described in FIG. 3. All of the components are the same with the following exception. The water that leaves the dewatering device (FIG. 2, device 14 or bioreactor (FIG. 2, device 20) enters the cathode chamber 40 of the microbial fuel cell with its oxygen present. The oxygen is removed as described in FIG. 3 and then exits from the cathode chamber 46 and proceeds to the input port 48 of the anode chamber 50. In this implementation, there is also the capacity to add a smaller version of the traditional cathode chamber 38 as described in FIG. 3 in the event that additional oxidation capacity is required.

### System Balance

The electricity from the microbial generator is partially used to cover the electrical costs of the full system and one important novel claim for this invention is the collocation of these devices (bioreactor, dewatering, microbial generator) configured so that they can be optimized for the best net combination of electricity and biomass as the two products of this biological solar power plant. The water pumps and blowers in the bioreactors consume substantial amounts of power balanced by the growth rate that becomes enhanced as the amount of mixing and aeration are increased. The dewatering and drying are very power intensive and the power use is proportional to the level of extraction. Dewatering devices tend to use much more power to extract smaller microbes. A device that uses coarse screens will use little power and extract little biomass. One that removes particles as fine as 3-5 micrometers in diameter will use a very large amount of power.

The particles that are not extracted pass through into the microbial fuel cell, along with the dissolved organic matter. These are converted to electricity at very high efficiency. Thus, there is a balance between electricity consuming components of the device that produce biomass and electricity production in the microbial generator. Increased biomass production both consumes more power and leaves less biomass to be converted to electricity. Conversely, extracting only the easiest to remove biomass both uses little electricity and leaves lots of biomass for electricity production. At one extreme, this device could just produce electricity. However, energy independence requires that the United States have both renewable electricity and renewable liquid fuels. This device provides for the production of both. The user balances the value of the electricity product with the value of the biomass or its derivative products, both fuels (e.g. biodiesel, jet fuel, ethanol, etc) or non-fuel particulate products (e.g. nutraceuticals, fish food, etc). The user will generally run the system so that 100% of the electricity costs are covered by local production in the microbial generator part of the system. This reduces the costs of production of particulate algae dramatically. The balance of the resulting photosynthesis can be made into the combination of biomass and electricity that maximizes the total value from the system, more biomass when it is more valuable, more electricity when it has more value.

The device can be further enhanced by the combination with other forms of electricity production like solar panels and windmills. These episodic forms of electricity production require surrounding land use that is compatible. Since the bioreactors absorb solar energy into the algae, they cannot be shaded. However, new solar panel technologies are coming online that allow visible light to pass through and create electricity out of the infrared and ultraviolet wavelengths. These could be deployed over the bioreactors. In open pond and raceway bioreactors, this type of solar panel would also reduce evaporation. The spaces between raceways and near the dewatering and electricity production components can also be the site of traditional photovoltaic solar panels or windmills. The possible enhancement here is to time the routing of water through the microbial generators so that it fills in the gaps in electricity production that are inherent in solar and wind power. This can smooth out the total power flow off of the production site so that it is a more consistent and predictable source of renewable electricity.

What is claimed is:

1. An apparatus for converting aquatic biomass into fuels and electricity comprising:
an algae bioreactor;
a biomass extraction system operatively connected to the output of the algae bioreactor wherein the bioreactor supplies water, algae, biomass and dissolved organic matter to the extraction system; and
a microbial generator operatively connected to the output of the extraction system wherein the generator produces electricity as an end product.

2. An apparatus according to claim 1 wherein the bioreactor is a device for holding water, algae, nutrients and carbon dioxide to provide materials required for the growth of algae in contact with adequate light to stimulate the growth of the algae.

3. An apparatus according to claim 1 wherein the biomass extraction system comprises:
a dewatering device for receiving water, algae and dissolved organic material from the bioreactor.

4. An apparatus according to claim 3 wherein the biomass extraction system includes
a biomass dryer connected to an output of the dewatering device for receiving wet algae from the dewatering device and producing dry algae product at the output.

5. An apparatus according to claim 1 wherein the microbial generator is a microbial fuel cell.

6. An apparatus according to claim 1 wherein a byproduct of the microbial generator is water, carbon dioxide and nutrients for algae and including means for feeding back the water, carbon dioxide and nutrients to the algae bioreactor to supplement an initial charge of algae, water, nutrients, and carbon dioxide in the algae bioreactor.

7. An apparatus according to claim 5 including means for transmitting electricity from the microbial generator to the dewatering device.

8. An apparatus according to claim 5 including means for transmitting electricity from the microbial generator to the biomass dryer.

9. An apparatus according to claim 5 wherein the microbial fuel cell comprises two chambers separated by a selectively permeable membranes.

10. An apparatus according to claim 9 wherein a first side of the membrane is an anode and the second side of the membrane is a cathode.

11. An apparatus according to claim 2 including a source of sunlight, algae carbon dioxide and water for providing an initial charge of materials for the algae bioreactor.

12. An apparatus according to claim 11 wherein the source of nutrients, carbon dioxide and water is an effluent from a power plant.

13. An apparatus according to claim 11 wherein the source of nutrients, carbon dioxide and water is the effluent from an animal farm or fish farm.

14. An apparatus according to claim 11 wherein the source of nutrients, carbon dioxide and water is an effluent from a waste treatment facility.

15. An apparatus according to claim 1 wherein the operative connection of the bioreactor to the biomass extraction system is provided by one or more pumps.

16. An apparatus according to claim 1 wherein the bioreactor comprises a raceway.

17. An apparatus according to claim 1 wherein the algae bioreactor comprises an open body of water.

18. An apparatus according to claim 1 wherein the operative connection of the bioreactor to the biomass extraction system is provided by a combination of pumps and gravity flow.

19. An apparatus according to claim 1 wherein the bioreactor is covered by a solar panel that passes visible light through the panel and uses non-visible light to generate electricity.

20. An apparatus according to claim 1 wherein the apparatus is co-located with an intermittent external source of electricity and further wherein power generated by the apparatus and its algae are used to augment the total electricity provided by filling in during the periods of low power production from the intermittent source.

21. A method for continuous culturing of microalgae to produce electricity and biomass comprising the steps of:
providing an algae bioreactor in the form of an open expanse within a confined boundary;
providing an initial algae charge in the expanse and nutrients, water and carbon dioxide;
exposing the expanse to light;
harvesting a portion of microalgae after a predetermined period and adding a replacement charge of nutrients to the harvested portion of the charge;
directing the harvested portion to a biomass extraction system having a dewatering device and a biomass dryer;
directing a portion of the algae from the dewatering device to the biomass dryer;
directing the remaining portion of the algae to a microbial generator;
processing the portion of the algae in the microbial generator to produce electricity; and
directing the water and nutrients from the generator back to the bioreactor as a source of nutrients to the unharvested algae in the bioreactor.
